(19) United States
(12) Patent Application Publication
(10) Pub. No.: US 2007/0245413 A1
(43) Pub. Date: Oct. 18, 2007

(54) Trusted Cryptographic Switch

(75) Inventors: John C. Andolina, Vista, CA (US); Dennis J. Bourget, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ViaSat, Inc., Carlsbad, CA (US)

(21) Appl. No.: 11/428,520

(22) Filed: Jul. 3, 2006

Related U.S. Application Data
(60) Provisional application No. 60/697,071, filed on Jul. 5, 2005.
(60) Provisional application No. 60/697,072, filed on Jul. 5, 2005.

(51) Int. Cl. G06F 15/16

(52) U.S. Cl. 726/11

(57) ABSTRACT

A cryptographic switch for routing information is disclosed. The cryptographic switch includes a first and second input ports, a first and second output ports and a first and second cryptographic paths. The first cryptographic path is configured to programmably couple between at least one of the first or second input ports and at least one of the first or second output ports. The second cryptographic path is configured to programmably couple between at least one of the first or second input ports and at least one of the first or second output ports.

This application claims the benefit of and is a non-provisional of both U.S. Provisional Application Ser. No. 60/697,071 filed on Jul. 5, 2005; and U.S. Provisional Application Ser. No. 60/697,072 filed on Jul. 5, 2005, which are both assigned to the assigner hereof and hereby expressly incorporated by reference in their entirety for all purposes.

This application is related to all of U.S. patent application Ser. No. ______, filed on the same date as the present application, entitled “TRUSTED CRYPTOGRAPHIC PROCESSOR” (temporarily referenced by Attorney Docket No. 017018-007230US); U.S. patent application Ser. No. ______, filed on the same date as the present application, entitled “SYNCHRONIZED HIGH-ASSURANCE CIRCUITS” (temporarily referenced by Attorney Docket No. 017018-007210US); and U.S. patent application Ser. No. ______, filed on the same date as the present application, entitled “TASK MATCHING FOR COORDINATED CIRCUITS” (temporarily referenced by Attorney Docket No. 017018-007220US); which are all assigned to the assigner hereof and hereby expressly incorporated by reference in their entirety for all purposes.

### BACKGROUND

This disclosure relates in general to cryptographic processing and, but not by way of limitation, to programmable cryptographic processing.

Cryptographic systems are used to secure information. Information systems have advanced as we progress into the Information Age. Cryptographic systems have not kept pace. Only a single algorithm is supported along a single processing path to process items at the highest security levels.

New developments in cryptographic design often obsolete older systems. Cryptographic systems are inflexible and cannot incorporate new developments once fielded. Design of new cryptographic systems is expensive and time consuming. Often a new cryptographic system must be produced for each deployment to cover different classification levels and security issues.

In modern cryptosystems, there is a need for multi-port (multi-channel) operation, where one cryptosystem can support multiple interfaces on both the plain text and cipher text interfaces. Current cryptosystems are designed in an unscalable architecture such that ports are added with a linear rise in circuit size and/or complexity. For more complex cryptographic systems, multiple paths at multiple classifications may also be used. Each path may have a different cryptographic device. Interfacing various devices make for a complex system. Each different cryptographic device may be different or configured differently to support complex data transport paths.

In high-assurance applications such as cryptosystems, there is typically a need to have redundant functions operating in parallel and continuously monitored to ensure correct operations. This monitoring can be particularly problematic when multiple microprocessors need to operate in a synchronized but independent manner. Regardless of whether the microprocessors share the same clock or have independent clocks, the microprocessors must respond to asynchronous events such as interrupts. Because of the asynchronous environment, the processors may execute instructions out of order from time to time, even when they are executing the same code base. This can result in different outputs from the microprocessors causing external monitoring functions to detect a mismatch and suspend operations. High assurance design principles dictate certain levels of functional and physical separation. The design issue arises because redundant data processing elements must always be ensured of processing the same information in the same order with the same results.

In a secure system, there is often a need to have data path reconfiguration for different system operations. In a high-assurance secure system, this reconfiguration function is typically established by the same redundant system elements that perform the primary functions. Both these types of processes must also be monitored to ensure correct operations. This monitoring can be particularly problematic, for example, when requests for data path reconfiguration occur asynchronously to the redundant decision making logic. Because of the asynchronous environment, the redundant decision making logic may occasionally come to different outcomes and the monitoring logic needs to provide a recovery mechanism to re-arbitrate for the correct data path before the data path is reconfigured.

Commercial switches are not aware of security level. These switches may have virtual private network (VPN) capabilities to cryptographically protect a channel, but lack sophistication. A VPN provides a protected link between two networks over an unprotected network, such as the Internet. Some switches may support a number of VPN connections with differing negotiated protocols.

### SUMMARY

In one embodiment, the present disclosure provides a cryptographic switch for routing information. The cryptographic switch includes a first and second input ports, a first and second output ports and a first and second cryptographic paths. The first cryptographic path is configured to programmably couple between at least one of the first or second input ports and at least one of the first or second output ports. The second cryptographic path is configured to programmably couple between at least one of the first or second input ports and at least one of the first or second output ports.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of a switching cryptographic system;

FIG. 2 depicts a block diagram of an embodiment of a switching cryptographic processor;

FIG. 3 depicts a block diagram of an embodiment of a switched crypto path;

FIG. 4 illustrates a flowchart of an embodiment of a process for configuring the switching cryptographic system;

FIG. 5 illustrates a flowchart of an embodiment of a process for processing messages with the switching cryptographic system; and

FIG. 6 illustrates a flowchart of an embodiment of a process for processing messages with the switching cryptographic processor.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

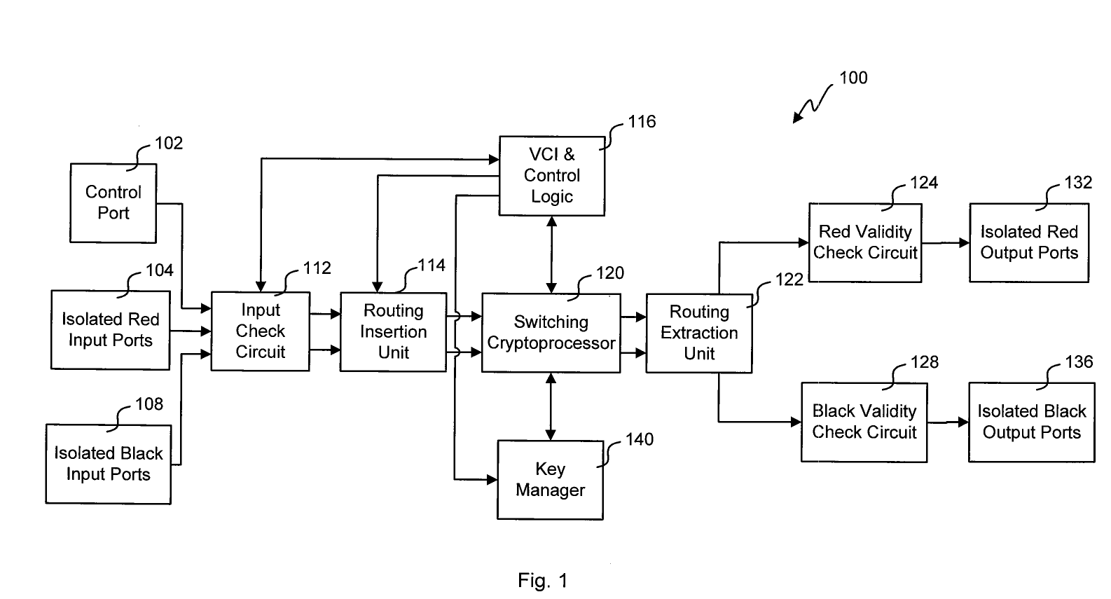

Referring first to FIG. 1, a block diagram of an embodiment of a switching cryptographic (“crypto”) system 100 is shown. The crypto system 100 can process messages on any of the input ports 104, 108 in a dynamic manner. Switching allows dynamically configuring the processing and ports that are used for particular messages. Checks of some sort are performed both before and after crypto processing. The crypto system 100 can separate processing of messages having different security levels. Encryption, decryption, guarding, and bypass can be performed by addressable processing nodes (APNs) in crypto system 100. APNs are the basic processing elements of cryptosystem 100. This disclosure uses the term “red” to refer to plaintext information and “black” to refer to ciphertext information.

A control port 102 allows programming the crypto system 100 to configure checks that are performed, various crypto paths and keys. Virtual circuit indexes (VCIs) are defined that specify the ports, the APNs, the order the APNs are used, checks performed, and any keys. The sole table shows various VCIs, their checks, route through the crypto system 100, any guarding and/or key(s) used, etc. There could be any number of VCIs that cause a message to be processed differently using the crypto system 100.

TABLE
Virtual Circuit Configuration

| Virtual | | | | |
|---|---|---|---|---|
| Circuit | | | | |
| Index | Key | Checks | Route | Information |
| 00 h | 07 h | Classification | InputPort0 | Secret PT Input |
| | | Format | | Port |
| | | Frequency | APN0, APN4, | Reformat & AES 256 |
| | | | APN3 | Encryption |
| | | | OutputPort2 | Secret CT Output |
| | | | | Port |
| 01 h | 03 h | Classification | InputPort0 | Secret PT Input |
| | | Format | | Port |
| | | | APN1, APN2 | AES 256 Encryption |
| | | | | with Token |
| | | | OutputPort2 | Secret CT Output |
| | | | | Port |
| 02 h | | Format | InputPort1 | Top Secret PT |
| | | | | Input Port |
| | | | APN0, APN3 | Reformat & Bypass |
| | | | OutputPort1 | Top Secret PT |
| | | | | Output Port |

The control port 102 is a protected port in this embodiment. A host computer can interact with the control port 102 if the proper formatting, protocol and crypto protection is used. Some embodiment only allow programming the crypto system 100 in a controlled environment to prevent reprogramming in the field. In some cases, some programming is performed in a controlled environment, but other programming is allowed in the field. By controlling the interface to the control port 102 cryptographically, unwanted programming can be avoided in one embodiment. Only those with an understanding of the protections, protocols and formatting on the control port 102 can modify the programming of the crypto system 100.

There are isolated red input (IRI) ports 104 and isolated black input (IBI) ports 108 to receive messages in this embodiment. The IRI ports 104 receive plaintext information and the IBI ports 108 receive ciphertext information in the form of messages. Each message includes a VCI and a data payload. Both the IRI ports 104 and IBI ports 108 each have several separate ports that are isolated from each other. This embodiment includes four IRI ports 104 and four IBI ports 108 where each port remains isolated from all other ports 104, 108 during normal operation.

In one embodiment, different ports are used for different classification levels such that any information of the wrong classification level at a port would be rejected. Some embodiments allow multiple VCIs to use the same port, while others limit the use of a port to a particular VCI or fix subset of the possible VCIs. In this embodiment, the red ports 104 are kept physically separate from the black ports 108 up to the cryptoprocessor 120.

Information received on any of the ports 102, 104, 108 is interrogated at an input check circuit 112. This interrogation may include a check of the VCI; a format, protocol, parity, checksums, cyclic redundancy checks, and/or structure check of the message; a classification level check; a frequency check to find inordinate level of messaging; and/or improper messaging. The interrogation can be configured differently for each port and/or VCI in various embodiments using the control port 102. For example, the Table shows that for VCI 01h a classification and format checks are performed. The input check circuit 112 keeps the red ports 104 physically isolated from the black ports 108 throughout the check process. Although this embodiment uses the input check circuit 112 to perform the frequency check, other embodiments could us an APN to perform that task.

There are many things that could result in the rejection of the message by the input check circuit 112. In one example, a secret message may be received on a classified port as determined by the VCI or metadata indicating classification. A check could determine that the number of messages over a time period is too high or too low such that the frequency test would fail. Certain VCIs are only valid for messages on certain ports such that a message with VCI 00h on InputPort1 would be rejected according to the Table. Errors in the formatting or structure of the message would be found with the input check circuit 112. Improper messaging that might be found could include messages at the improper time, for example, an initialization message during normal operation would be unusual and found by the input check circuit 112.

The VCI and control (VAC) logic 116 is set up with the control port 102. Each message provides a VCI integral with the message or sent separately in various embodiments. When a VCI is received it is passed to the VAC logic 116, which configures the switching cryptoprocessor 120 to perform the proper algorithms to the data payload from the message. The VAC 116 causes the cryptoprocessor 120 to effectuate a cryptographic path from one input port 104, 108 to one output port 132, 136. The VAC logic 116 indicates to the key manager 140 the key to use for the cryptographic path. The VAC logic 116 also loads routing information into the routing insertion unit 114, which inserts the cryptoprocessor routing information into the traffic data packet. The routing information specifies the cryptographic path to use.

The cryptoprocessor 120 performs cryptographic processing, which may involve keys. The VAC logic 116 indicates to the key manager 140 which keys to use. The key manager 140 passes the needed keys to the cryptoprocessor 120 for each VCI and message.

Once the cryptoprocessor 120 has completed processing, the red information is kept physically separated from the black information. The cryptoprocessor routing information is removed by the routing information extraction unit 122. Separate validity checks are performed for the red and black information. The red and black validity check circuits 124, 128 can perform several checks after the cryptographic processing. Each validity check circuit 124, 128 can compare results from any redundant processing and check formatting, parity, checksums, and/or cyclic redundancy checks. The types of checks performed can be programmable and activated by as a function of the VCI.

After all the processing is completed and the validity checks performed, the successful messages are coupled to the output port indicated in the VCI. There are both isolated red output (IRO) ports 132 and isolated black output (IBO) ports 136. Messages on these ports are kept physically separated from the cryptoprocessor 120 forward. A host computer or some other system is coupled to the output ports 132, 136 to take the message after processing.

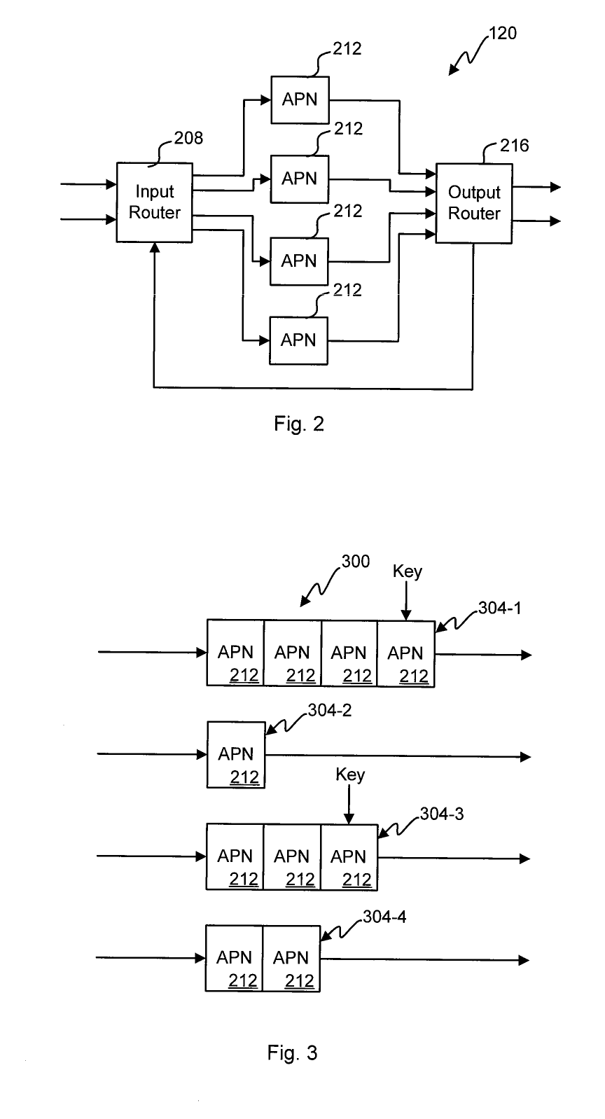

With reference to FIG. 2, a block diagram of an embodiment of the switching cryptographic processor 120 is shown. For clarity, the VAC and key data paths of blocks 116 and 140 are not shown. In this embodiment, the various isolated data paths from the input ports 104, 108 are coupled to the input router 208, which then determines the proper path for the packet through the various APNs 212 as specified in the VCI. Specifically, the VAC logic 116 uses the input and output routers 208, 216 to put the data payload from the message through a sequence of one or more APN 212. The output router 216 connects to the input router 208 to allow looping back to use additional APN 212. The VCI specifies the processing and the VAC logic 116 implements that processing before passing the result through the output router 216.

Referring next to FIG. 3, a block diagram of an embodiment of a switched crypto path 300 is shown. This diagram figuratively shows what the switching fabric achieves by looping the data payload through a series of one or more APNs 212, each of which may contain unique and/or identical functions. The connections between the APNs 212 are programmable and a virtual connection achieved by the input and output routers 208, 216 (not shown in this figure, see FIG. 2). The input router 208 takes a given data payload from a particular input port before it is put through a series of APNs 212. Some of the APNs 212 may use one or more keys supplied by the key manager 140. The series of APNs 212 create a cryptographic path 304. For example, the second cryptographic path 304-2 may correspond to a bypass function. In another example, the fourth cryptographic path 304-4 may correspond to VCI 02h to perform a guard function (validity confirmation) on the message in one APN 212 and a reformatting function with the other APN 212. The reformatted and validated message is sent to the output router 216 to connect with the output port 132, 136 specified by the VCI.

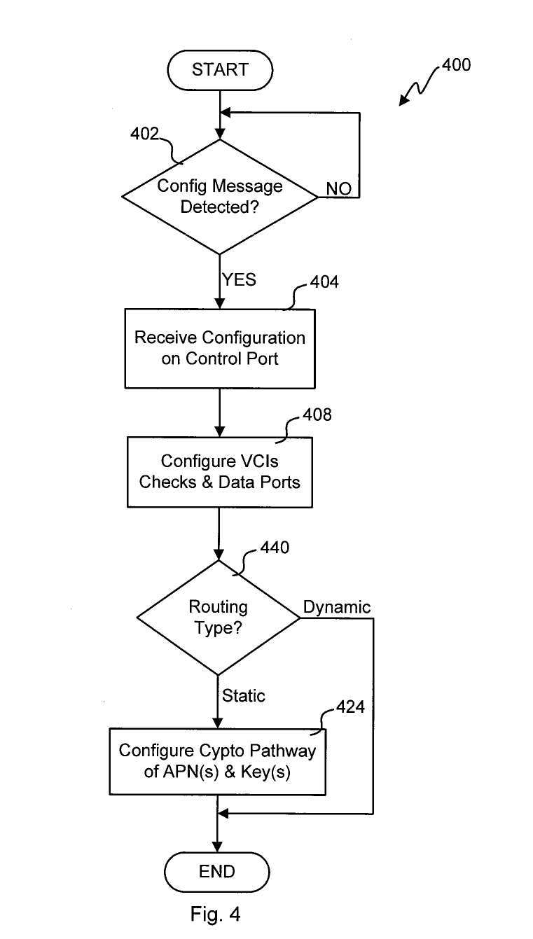

Referring next to FIG. 4, a flowchart of an embodiment of a process 400 for configuring the switching cryptographic system 100 is shown. The depicted part of the process begins in block 402, where the configuration is triggered when a message containing configuration information is detected on the control port 102. The configuration message(s) are received in block 404. In block 408, the VCIs, checks and data ports are configured. This would include specifying the classification levels for particular input and output ports 104, 108, 132, 136 and indicating the checks, keys and processing for each cryptoprocessing path 304 specified by the VCIs.

Additionally, the type of routing is configured in step 440. Configuration can allow static routing that allows a single input or output port to act for a single cryptographic path 304. For example, one input port 104, 108 could be configured to always use a particular switched cryptographic path 304 and a particular output port 132, 136. Such pre-configuration would be performed in block 424. Where dynamic routing is used, the cryptographic paths 304 can be specified on a message-by-message basis.

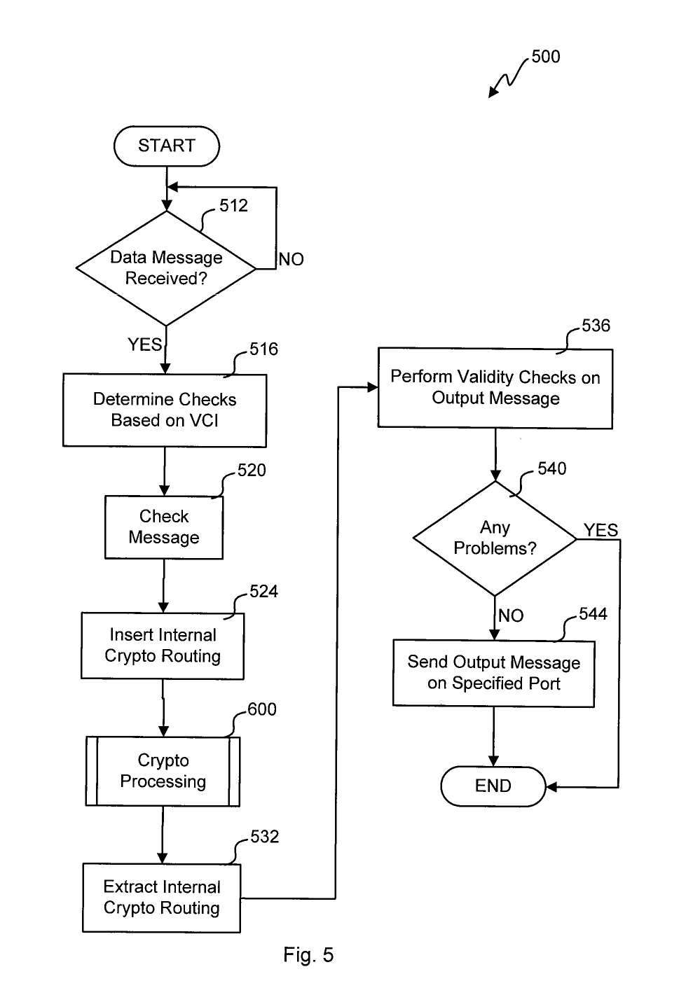

With reference to FIG. 5, a flowchart of an embodiment of a process 500 for processing messages with the switching cryptographic system 100 is shown. In block 512, a data message is accepted from input port 104 or 108. The VCI is passed to the VAC logic 116 in step 516 to configure any processing by the input check circuit 112. In some embodiments, the input check circuit 112 is preconfigured for a particular input port 104, 108. The input check circuit 112 performs any specified checks in step 520. The internal routing to implement cryptoprocessing pathway 304 is inserted into the input message in block 524. The internal routing specifies to the switching cryptoprocessor 120 the APN(s) 212 and key(s) to use. The crypto processing is performed by the switching cryptoprocessor 120 in block 600.

The output message from the cryptoprocessor is produced and any internal routing information is removed in block 532. Any validity checks specified by the VCI are performed in step 536. In block 540, any problems are determined. The problems could have occurred at the input check circuit 112, at the validity check circuits 124, 128 or elsewhere. Where there is any problem, processing ends and any error message can be generated and the error logged in some embodiments. If there are no problems in block 540, the processed message is send out the specified output port 132, 136.

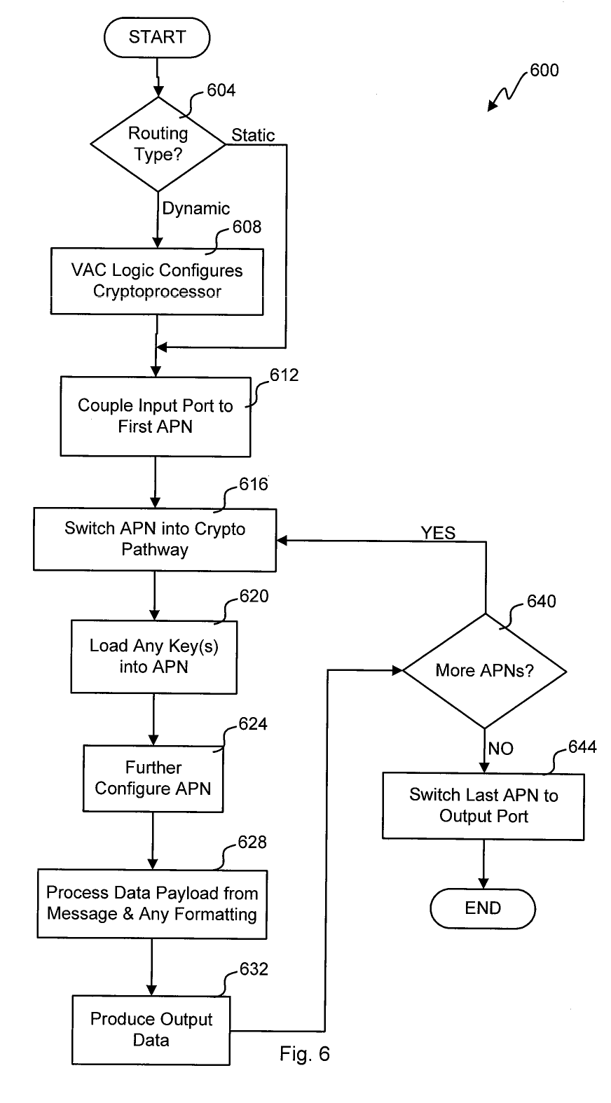

Referring next to FIG. 6, illustrates a flowchart of an embodiment of a process 600 for processing messages with the switching cryptographic processor 120 is shown. The depicted portion of the process begins in block 604 where a determination is made whether the VCI corresponds to a static or dynamic routing. Where dynamic routing is selected, the cryptoprocessor 120 is programmed by the VAC logic 116 in step 608. For static routing, the cryptoprocessing path 304 is already configured such that processing skips block 608. The input message is coupled to the first APN 212 in block 612 via input router 208.

The APN 212 is switched into the cryptographic path 304 in block 616 using the switching fabric 208, 216. Any keys are loaded by the key manager 140 into the APN 212. Any further configuration to the APN 212, such as initialization vector loading, flushing, etc., is performed in step 624. Processing is performed by the APN 212 along with any formatting in block 628. The output from the APN 212 is produced in step 632. Where there are additional APNs 212 in the cryptographic path 304, block 640 loops processing back to step 616 to complete the next APN 212. This looping process continues until there are no more APNs 212 specified. Where there are no more APNs 212 specified, processing passes from block 640 to block 644. The last APN output message is switched to the routing extraction unit 122 in block 644.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other mediums capable of storing, containing or carrying instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

For a software implementation, the techniques, processes and functions described herein may be implemented with modules (e.g., procedures, functions, and so on) that perform the functions described herein. The software codes may be stored in memory units and executed by processors. The memory unit may be implemented within the processor or external to the processor, in which case the memory unit can be communicatively coupled to the processor using various known techniques.

While the principles of the disclosure have been described above in connection with specific apparatuses and methods, it is to be clearly understood that this description is made only by way of example and not as limitation on the scope of the disclosure.

What is claimed is:

1. A cryptographic switch for routing information, the cryptographic switch comprising:
a first input port;
a second input port;
a first output port;
a second output port;
a first cryptographic path configured to programmably couple between at least one of the first or second input ports and at least one of the first or second output ports; and
a second cryptographic path configured to programmably couple between at least one of the first or second input ports and at least one of the first or second output ports.

2. The cryptographic switch for routing information as recited in claim 1, further comprising a path controller that is configured to programmably couple the first cryptographic path to one of the first or second input ports and one of the first or second output ports for a first data packet.

3. The cryptographic switch for routing information as recited in claim 2, wherein the path controller is programmed by metadata embedded in the first data packet to select at least three of:
one of the first or second input ports,
the first cryptographic path,
one of the first or second output ports, and
a cryptographic key.

4. The cryptographic switch for routing information as recited in claim 1, further comprising a path controller that is configured to programmably couple the second cryptographic path to one of the first or second input ports and one of the first or second output ports for a second data packet.

5. The cryptographic switch for routing information as recited in claim 4, wherein the path controller is programmed by metadata embedded in the second data packet to select at least three of:
one of the first or second input ports,
the second cryptographic path,
one of the first or second output ports, and
a cryptographic key.

6. The cryptographic switch for routing information as recited in claim 1, wherein:
the first input port is configured for a first classification level;
the second input port is configured for a second classification level; and
the first classification level is different from the second classification level.

7. The cryptographic switch for routing information as recited in claim 1, wherein the first input port is configured to reject data packets of the second classification level.

8. The cryptographic switch for routing information as recited in claim 1, wherein:
the first output port is configured for a first classification level;
the second output port is configured for a second classification level; and
the first classification level is different from the second classification level.

9. The cryptographic switch for routing information as recited in claim 8, wherein the first input port is configured to reject data packets of the second classification level.

10. The cryptographic switch for routing information as recited in claim 1, wherein the first cryptographic path passes through a plurality of processing nodes.

11. The cryptographic switch for routing information as recited in claim 10, wherein at least one of the plurality of processing nodes performs a cryptographic function.

12. The cryptographic switch for routing information as recited in claim 1, wherein the second cryptographic path passes through a plurality of processing nodes.

13. The cryptographic switch for routing information as recited in claim 12, wherein at least one of the plurality of processing nodes performs a cryptographic function.

14. A data signal embodied in a carrier wave, the data signal comprising a plurality of packets, the plurality of packets comprising a packet, the packet comprising:
a data payload wherein the data payload is cryptographically classified; and
metadata, wherein the metadata is configured to specify at least three of a following:
one of a first input port or a second input port,
one of a first cryptographic path or a second cryptographic path,
one of a first output port or a second output port, and
a cryptographic key from a plurality of cryptographic keys.

15. The data signal embodied in the carrier wave as recited in claim 14, wherein the data signal is processed by a cryptographic switch.

16. The data signal embodied in the carrier wave as recited in claim 14, wherein the metadata is further configured to specify a classification level of the data payload.

17. The data signal embodied in the carrier wave as recited in claim 14, wherein the metadata is configured to program a path controller of a cryptographic switch to effectuate the specification of the metadata.

18. The data signal embodied in the carrier wave as recited in claim 14, wherein the metadata is checked by a cryptographic switch before effectuating the specification of the metadata.

19. The data signal embodied in the carrier wave as recited in claim 14, wherein a cryptographic switch rejects the packet when the metadata specifies the first input port and the packet is received on the second input port.

20. A method for processing cryptographically, the method comprising steps of:
receiving a first data packet comprising a data payload and metadata;
processing the metadata, wherein the processing step comprises at least three of a following sub-steps:
determining one of a first input port or a second input port,
determining one of a first cryptographic path or a second cryptographic path,
determining one of a first output port or a second output port, and
determining a cryptographic key from a plurality of cryptographic keys;
processing the data payload using one of the first or second cryptographic paths; and
transmitting a second data packet with the processed data payload.

21. The method for processing cryptographically as recited in claim 20, wherein the processed data payload is cryptographically related to the data payload.

22. The method for processing cryptographically as recited in claim 20, wherein the second-listed processing step further comprises a sub-step of processing the data payload with a plurality of processing nodes.

23. The method for processing cryptographically as recited in claim 22, wherein the processing sub-step comprises a step of cryptographically processing the data payload using the plurality of processing nodes.

24. The method for processing cryptographically as recited in claim 20, wherein:
the first input port uses a first classification level,
the second input port uses a second classification level, and
the first classification level is different from the second classification level.

25. The method for processing cryptographically as recited in claim 20, further comprising steps of:
processing second metadata from a third data packet; and
processing the third data packet using a different cryptographic path than that used for the first data packet.
